(19) United States
(12) Patent Application Publication
(10) Pub. No.: US 2019/0294886 A1
(43) Pub. Date: Sep. 26, 2019

(54) SYSTEM AND METHOD FOR SEGREGATING MULTIMEDIA FRAMES ASSOCIATED WITH A CHARACTER

(71) Applicant: HCL Technologies Limited, Noida (IN)

(72) Inventors: Prathameshwar Pratap SINGH, Noida (IN); Yogesh GUPTA, Noida (IN)

(21) Appl. No.: 16/354,195

(22) Filed: Mar. 15, 2019

(30) Foreign Application Priority Data
Mar. 23, 2018 (IN) 201811010818

(51) Int. Cl. G06K 9/00; G06K 9/62; G11B 27/031; G11B 27/30

(52) U.S. Cl. CPC G06K 9/00765; G06K 9/6201; G10L 17/005; G11B 27/031; G11B 27/3081; G06K 9/00718

(57) ABSTRACT

The present disclosure relates to system(s) and method(s) for segregating multimedia frames associated with a character. The system may store sample data corresponding to a set of characters, wherein the sample data may comprise one or more voice samples and one or more visual samples corresponding to each character. The system may receive a multimedia file with a set of multimedia frames. Each multimedia frame may comprise video data and audio data. The system may identify one or more clusters of multimedia frames from the set of multimedia frames. The one or more clusters of multimedia frames may be associated with a target character selected from the set of characters by comparing the multimedia file with the audio and visual data. The system may further comprise steps for generating a target multimedia file, wherein the target multimedia file is generated by combining the one or more clusters of multimedia frames.

### CROSS-REFERENCE TO RELATED APPLICATIONS AND PRIORITY

The present application claims benefit from Indian Complete Patent Application No. 201811010818 filed on 23 Mar. 2018 the entirety of which is hereby incorporated by reference.

### TECHNICAL FIELD

The present disclosure in general relates to the field of multimedia processing. More particularly, the present invention relates to a system and method to process multimedia file based on image recognition and voice recognition.

### BACKGROUND

In today's world, there are a lot of communicational, entertainment, advertisement, educational and live media streaming data in form of audio/video recording. Preferably, video and audio recording is always done for life events, live telecast, movies, news, social media, entertainment movies, training and educational programs. Unfortunately, video and audio data are big enough in size and day by day worldwide, its size is increasing. HD video is revolutionary for audience but in term of size, its pathetic and about one-minute video would take 300-700 MB. It is not only big enough but in present technologies, it has many different formats (Video itself has more 200 type formats).

Sometime end-user want to play, pause and listen some or few parts from entire recording. So most of the video/audio player and search engine gives capabilities to run forward/backward navigation in clip as traditional model. Some of the features which are desired while playing video but currently are not available in the art are listed as follows:

Hear only your favourite Character's voice from news debate (e.g. you as consumer want to mute everybody else and listen to one preferred person only).

Keep eyes on single person activity in crowded place. Watch and listen to only that.

Watch and listen a special moment or section from recorded marriage video.

Watch and listen favourite actor/actress scene from entire video.

Handle and hear call centre conversations between customer and your employee

Watch and listen specific participants from team meeting recordings. For example, a person just want to listen only customer speech rather than own or own team members speech.

Handling, analysing and processing data of video and audio is very tedious job. It requires lot of space and computing power to process such data. Accuracy of result is very low in terms of quality for Audio/video data.

### SUMMARY

Before the present systems and method for segregating multimedia frames associated with a Character is illustrated. It is to be understood that this application is not limited to the particular systems, and methodologies described, as there can be multiple possible embodiments that are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for segregating multimedia frames associated with a character. This summary is not intended to identify essential features of the claimed subject matter nor is it intended for use in determining or limiting the scope of the claimed subject matter.

In another implementation, a system for segregating multimedia frames associated with a character, is illustrated. The system comprises a memory and a processor coupled to the memory, further the processor is configured to execute programmed instructions stored in the memory. In one embodiment, the processor may execute programmed instructions stored in the memory for storing sample data corresponding to a set of characters. The sample data comprises one or more voice samples and one or more visual samples corresponding to each character from the set of characters. In one embodiment, the processor may execute programmed instructions stored in the memory for receiving a multimedia file. The multimedia file may comprise a set of multimedia frames. Each multimedia frame may comprise at least one of video data and audio data. In one embodiment, the processor may execute programmed instructions stored in the memory for identifying one or more clusters of multimedia frames from the set of multimedia frames. The one or more clusters of multimedia frames may be associated with a target character selected from the set of characters. In one embodiment, each cluster of multimedia frames is identified by comparing one or more visual samples, of the target character, with video data of each multimedia frame, and comparing one or more voice samples, of the target character, with audio data of each multimedia frame. In one embodiment, the processor may execute programmed instructions stored in the memory for generating a target multimedia file, wherein the target multimedia file is generated by combining the one or more clusters of multimedia frames.

In one implementation, a method for segregating multimedia frames associated with a character, is illustrated. The method may comprise steps for storing sample data corresponding to a set of characters. The sample data comprises one or more voice samples and one or more visual samples corresponding to each character from the set of characters. The method may comprise steps for receiving a multimedia file. The multimedia file may comprise a set of multimedia frames. Each multimedia frame may comprise at least one of video data and audio data. The method may comprise steps for identifying one or more clusters of multimedia frames from the set of multimedia frames. The one or more clusters of multimedia frames may be associated with a target character selected from the set of characters. In one embodiment, each cluster of multimedia frames is identified by comparing one or more visual samples, of the target character, with video data of each multimedia frame, and comparing one or more voice samples, of the target character, with audio data of each multimedia frame. The method may comprise steps for generating a target multimedia file, wherein the target multimedia file is generated by combining the one or more clusters of multimedia frames.

In yet another implementation, a computer program product having embodied computer program for segregating multimedia frames associated with a character is disclosed. The program may comprise a program code for storing sample data corresponding to a set of characters. The sample data comprises one or more voice samples and one or more visual samples corresponding to each character from the set of characters. The program may comprise a program code for receiving a multimedia file. The multimedia file may comprise a set of multimedia frames. Each multimedia frame may comprise at least one of video data and audio data. The program may comprise a program code for identifying one or more clusters of multimedia frames from the set of multimedia frames. The one or more clusters of multimedia frames may be associated with a target character selected from the set of characters. In one embodiment, each cluster of multimedia frames is identified by comparing one or more visual samples, of the target character, with video data of each multimedia frame, and comparing one or more voice samples, of the target character, with audio data of each multimedia frame. The program may comprise a program code for generating a target multimedia file, wherein the target multimedia file is generated by combining the one or more clusters of multimedia frames.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system configured for segregating multimedia frames associated with a character, in accordance with an embodiment of the present subject matter.

FIG. 2 illustrates the system configured for segregating multimedia frames associated with a character, in accordance with an embodiment of the present subject matter.

FIG. 3 illustrates a method for segregating multimedia frames associated with a character, in accordance with an embodiment of the present subject matter.

### DETAILED DESCRIPTION

Some embodiments of the present disclosure, illustrating all its features, will now be discussed in detail. The words “storing”, “receiving”, “comparing”, “identifying”, “generating”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in segregating multimedia frames associated with a character, the exemplary, systems and method for segregating multimedia frames is now described. The disclosed embodiments of the system and method for segregating multimedia frames associated with a character are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for segregating multimedia frames associated with a character is not intended to be limited to the embodiments illustrated, but is to be accorded the widest scope consistent with the principles and features described herein.

The system enables a user to modulate video and audio data. The system is capable of processing multimedia files in real-time. The system is configured to process historically archived data as well as live streaming of audio/video. The system provides capabilities in consumer hand to play, point and listen audio/video based on his preference, wherein a user can decide and point to watch and listen one or specific actor from recorded or live streaming video, rest of the world will be muted and deprioritized for presence. The system has three major processing blocks namely a Speech Controller, a Visual Face Recognizer and Controller, and a Modulation and Frame Editor. The system may receive multimedia file (video/audio file) from multiple sources like video repository, live streaming or audio repository. After clustering, modulation and decomposition the final outcome (video/audio) produced to the user.

In one embodiment, the speech controller is mainly responsible to segregate and identify the character. The character may correspond to any a speaker, an actor, an animal or any other animated character in the video frames. The speech controller may process video frames as well as audio data only. For video frames, the speech controller enables voice forwarding and flow according to video frame and frame sequences. It works in sync with Visual Recognizer and Controller module to give seamless experience outcome to end-user by matching timestamp. In audio mode the speech controller performs clustering to identify the characters and then entire speech of a target character is aggregated and stored in single cluster. Further assembler recreate speech of each and every cluster sequentially. The speech controller enables a Video Frame Synchronizer, to process an multimedia file and creates synchronization of Audio frames with video cluster and frames. The speech controller enables a Clustering Engine. The Clustering Engine identifies and defines cluster based on voice recognition. Each cluster represents individual one person voice. The speech controller enables a Character Identifier & Assembler. The Character Identifier & Assembler helps to identify character and create assembling sequence for clusters.

The system further enables a Visual Recognizer and Controller. The Visual Recognizer and Controller is responsible for visual detection and clustering of video frames for individual actor (human) from video. For example, in a video with ten people are sitting discussing and debating, then Visual Recognizer and Controller is configured to break the video into ten clusters. Every individual actor of video will have its own frames in individual cluster. Visual Recognizer and Controller always work in sync with Speech Controller module to pick and collect respective actor voices only while playing. In one embodiment, the Visual Face Recognizer & Controller may have four sub modules namely Video Clustering Engine, Actor Segregator, Frame Manager, and Voice Marker. The Video Clustering Engine is responsible to define and create clusters for each and individual actor/person. All data frames belonging to single actor/person are mapped in respective clusters. The Actor Segregator is responsible to identify the video actor and sync with clustering engine so that each frame can have its right position inside right clusters. It usage facial recognition technique to identify the actor. The Frame Manager is responsible to manage input (live streaming or video file) and define sequence/queue of output frames. It work in sync with Audio identifier module so that video with audio can play seamless for end user. The Voice Marker enables synchronization to keep frame and voice in sync with voice marker comes in role. It helps the player to keep audio/video together for individual actor in clustered video.

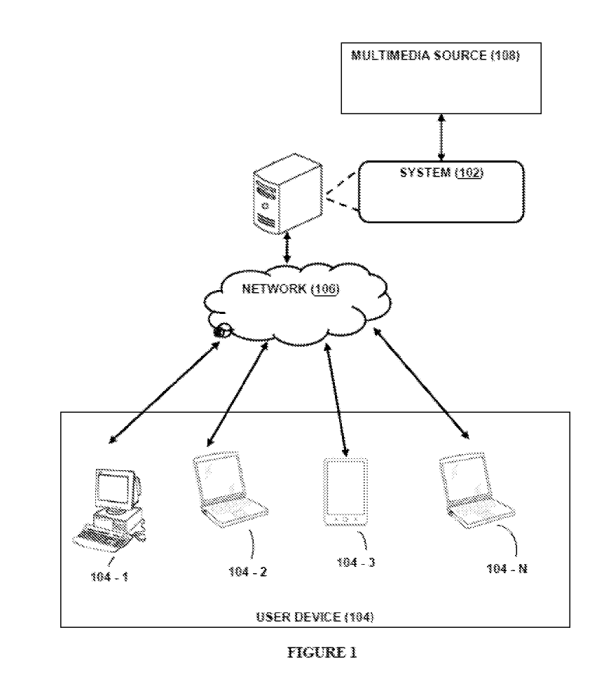

The system further enables a Modulation and Frame Decomposer. The Modulation and Frame Decomposer is core component of the system. It gives capability to queue, compose, modulate and play video and audio for seamless experience to end user. It loads clustering records in queue from Speech and Visual Face Recognizer then produce output by rearranging video and audio frames. The Modulation and Frame Decomposer has two sub modules Cluster Queuing and Player and Modulation. The Player and modulation helps any player read and play video/audio (stream). Behind the scene, modified (virtual/in memory) stream is being passed to player (any video player) for uninterrupted playing in supported format. The Cluster Queuing is configured to cluster queuing module is responsible to manage virtually rearranged sequence of video and audio frames. It helps Player module to pick and play video/audio and defined clusters sequence. Further, the network implementation of system configured for segregating multimedia frames associated with a character is illustrated with FIG. 1.

Referring now to FIG. 1, a network implementation 100 of a system 102 for segregating multimedia frames associated with a character is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a server. Further, the system 102 may be implemented in a cloud network. The system 102 may further be configured to communicate with a multimedia source 108. The multimedia source 108 may correspond to TV broadcaster, Radio, Internet and the like. The system may be configured to receive a multimedia file from the multimedia source 108. This multimedia file is then processed in order to segregating multimedia frames associated with a character.

Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

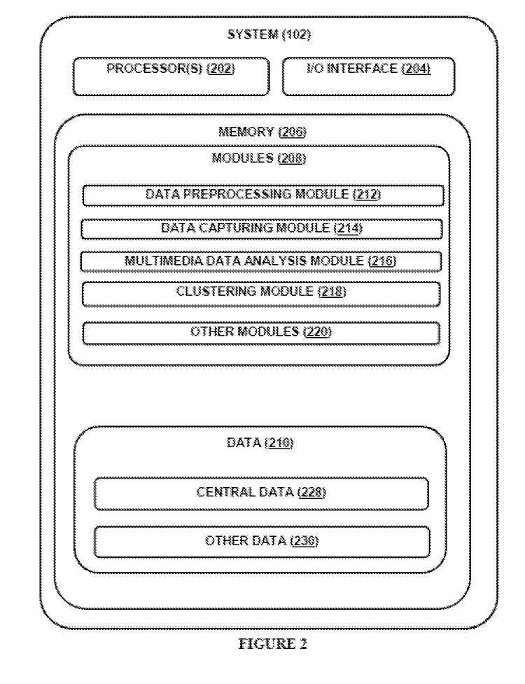

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), File Transfer Protocol (FTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like. In one embodiment, the system 102 may be configured to receive one or more multimedia files from the multimedia source 108. Once the system 102 receives the one or more multimedia files, the system 102 is configured to process the one or more multimedia files as described with respect to FIG. 2.

Referring now to FIG. 2, the system 102 is configured for segregating multimedia frames associated with a character in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the modules 208 may be configured to perform functions of the speech controller, visual face recognition & controller, and modulation & frame decomposer. The module 208 may include a data pre-processing module 212, a data capturing module 214, a multimedia data analysis module 216, a clustering module 218, and other modules 220. The other modules 220 may include programs or coded instructions that supplement applications and functions of the system 102.

The data 210, amongst other things, serve as a repository for storing data processed, received, and generated by one or more of the modules 208. The data 210 may also include a central data 228, and other data 230. In one embodiment, the other data 230 may include data generated as a result of the execution of one or more modules in the other modules 220. In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102. The functioning of all the modules in the system 102 is described as below:

### Data Preprocessing Module 212

In one embodiment, the data pre-processing module 212 may be configured for storing sample data corresponding to a set of characters. The sample data comprises one or more voice samples and one or more visual samples corresponding to each character from the set of characters. The voice samples may be historically captured from each of the characters such that the voice samples may be used for speech recognition. The visual samples may be in the form of images of the user. The images may be used for face recognition in a video sequence using image processing/face recognition algorithms. In one embodiment, the sample data may be stored in the form of central data 228. In one embodiment, the raw data may be pre-processed and dynamically updated based on the multimedia files received by the system.

### Data Capturing Module 214

In one embodiment, the data capturing module 214 is configured to receive a multimedia file. The multimedia file may comprise a set of multimedia frames. In one embodiment, each multimedia frame may comprise at least one of video data and audio data. The video data may correspond to a set of video frames in a video clip. Further, the audio data may correspond to an audio recording associated with the video clip. In one embodiment, the data capturing module 214 may a multimedia file with only video data or audio data.

### Multimedia Data Analysis Module 216

In one embodiment, the multimedia data analysis module is configured to identify one or more clusters of multimedia frames from the set of multimedia frames. The one or more clusters of multimedia frames may be associated with a target character selected from the set of characters. The target character may be selected by a user of the system using the user device 104. In one embodiment, in order to identify each cluster of multimedia frames, initially the multimedia data analysis module is configured to compare one or more visual samples, of the target character, with video data of each multimedia frame. The one or more visual samples are compared with the video data of each multimedia frame using image recognition algorithm. This step may result into identification of a subset of video frames. The subset of video frames may contain images of the target character as well as some of the other characters. In order to exactly identify clusters in which the target user is speaking, the multimedia data analysis module 216 is configured to compare one or more voice samples, of the target character, with audio data of each multimedia frame. The one or more voice samples is compared with audio data of each multimedia frame using voice recognition algorithm. As a result, by comparison of both the parameters (video data and audio data) the multimedia data analysis module is configured to identify one or more clusters of multimedia frames associated with the target character.

### Clustering Module 218

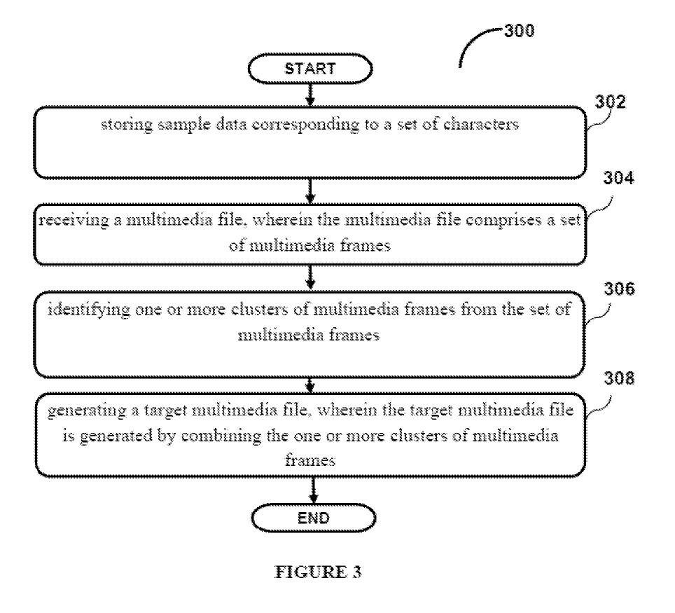

In one embodiment, the clustering module 218 is configured to generate a target multimedia file. The target multimedia file is generated by combining the one or more clusters of multimedia frames. The one or more clusters of multimedia frames are combined based on the position of the clusters of multimedia frames in the multimedia file to generate the target multimedia file. Further, method for segregating multimedia frames associated with a character is illustrated with respect to FIG. 3.

Referring now to FIG. 3, a method 300 for segregating multimedia frames associated with a character, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the data pre-processing module 212 may be configured for storing sample data corresponding to a set of characters. The sample data comprises one or more voice samples and one or more visual samples corresponding to each character from the set of characters. The voice samples may be historically captured from each of the characters such that the voice samples may be used for speech recognition. The visual samples may be in the form of images of the user. The images may be used for face recognition in a video sequence using image processing/face recognition algorithms In one embodiment, the sample data may be stored in the form of central data 228. In one embodiment, the raw data may be pre-processed and dynamically updated based on the multimedia files received by the system.

At block 304, the data capturing module 214 is configured to receive a multimedia file. The multimedia file may comprise a set of multimedia frames. In one embodiment, each multimedia frame may comprise video data and audio data. The video data may correspond to a set of video frames in a video clip. Further, the audio data may correspond to an audio recording associated with the video clip. In one embodiment, the data capturing module 214 may a multimedia file with only video data or audio data.

At block 306, the multimedia data analysis module 216 is configured to identify one or more clusters of multimedia frames from the set of multimedia frames. The one or more clusters of multimedia frames may be associated with a target character selected from the set of characters. The target character may be selected by a user of the system using the user device 104. In one embodiment, in order to identify each cluster of multimedia frames, initially the multimedia data analysis module is configured to compare one or more visual samples, of the target character, with video data of each multimedia frame. The one or more visual samples are compared with the video data of each multimedia frame using image recognition algorithm. This step may result into identification of a subset of video frames. The subset of video frames may contain images of the target character as well as some of the other characters. In order to exactly identify clusters in which the target user is speaking, the multimedia data analysis module 216 is configured to compare one or more voice samples, of the target character, with audio data of each multimedia frame. The one or more voice samples is compared with audio data of each multimedia frame using voice recognition algorithm. As a result, by comparison of both the parameters (video data and audio data) the multimedia data analysis module is configured to identify one or more clusters of multimedia frames associated with the target character.

At block 308, the clustering module 218 is configured to generate a target multimedia file. The target multimedia file is generated by combining the one or more clusters of multimedia frames. The one or more clusters of multimedia frames are combined based on the position of the clusters of multimedia frames in the multimedia file to generate the target multimedia file.

Although implementations for systems and methods for segregating multimedia frames associated with a character has been described, it is to be understood that the appended claims are not necessarily limited to the specific features or methods described. Rather, the specific features and methods are disclosed as examples of implementations for segregating multimedia frames associated with the character.

1. A method for segregating multimedia frames associated with a character, the method comprises steps of:
storing, by a processor, sample data corresponding to a set of characters, wherein the sample data comprises one or more voice samples and one or more visual samples corresponding to each character from the set of characters;
receiving, by the processor, a multimedia file, wherein the multimedia file comprises a set of multimedia frames, wherein each multimedia frame comprises at least one of video data and audio data;
identifying, by the processor, one or more clusters of multimedia frames from the set of multimedia frames, wherein the one or more clusters of multimedia frames are associated with a target character selected from the set of characters, wherein each cluster of multimedia frames is identified by
comparing one or more visual samples, of the target character, with video data of each multimedia frame, and
comparing one or more voice samples, of the target character, with audio data of each multimedia frame; and
generating, by the processor, a target multimedia file, wherein the target multimedia file is generated by combining the one or more clusters of multimedia frames.

2. The method of claim 1, wherein the one or more visual samples are compared with the video data of each multimedia frame using image recognition algorithm.

3. The method of claim 1, wherein the one or more voice samples is compared with audio data of each multimedia frame using voice recognition algorithm.

4. The method of claim 1, wherein the one or more clusters of multimedia frames are combined based on the position of the clusters of multimedia frames in the multimedia file to generate the target multimedia file.

5. A system for segregating multimedia frames associated with a character, the system comprising:
a processor;
a memory coupled to the processor, wherein the processor is configured to execute programmed instructions stored in the memory for:
storing sample data corresponding to a set of characters, wherein the sample data comprises one or more voice samples and one or more visual samples corresponding to each character from the set of characters;
receiving a multimedia file, wherein the multimedia file comprises a set of multimedia frames, wherein each multimedia frame comprises at least one of video data and audio data;
identifying one or more clusters of multimedia frames from the set of multimedia frames, wherein the one or more clusters of multimedia frames are associated with a target character selected from the set of characters, wherein each cluster of multimedia frames is identified by
comparing one or more visual samples, of the target character, with video data of each multimedia frame, and
comparing one or more voice samples, of the target character, with audio data of each multimedia frame; and
generating a target multimedia file, wherein the target multimedia file is generated by combining the one or more clusters of multimedia frames.

6. The system of claim 5, wherein the one or more visual samples are compared with the video data of each multimedia frame using image recognition algorithm.

7. The system of claim 5, wherein the one or more voice samples is compared with audio data of each multimedia frame using voice recognition algorithm.

8. The system of claim 5, wherein the one or more clusters of multimedia frames are combined based on the position of the clusters of multimedia frames in the multimedia file to generate the target multimedia file.

9. A computer program product having embodied thereon a computer program for segregating multimedia frames associated with a character, the computer program product comprises:
a program code for storing sample data corresponding to a set of characters, wherein the sample data comprises one or more voice samples and one or more visual samples corresponding to each character from the set of characters,
a program code for receiving a multimedia file, wherein the multimedia file comprises a set of multimedia frames, wherein each multimedia frame comprises at least one of video data and audio data;
a program code for identifying one or more clusters of multimedia frames from the set of multimedia frames, wherein the one or more clusters of multimedia frames are associated with a target character selected from the set of characters, wherein each cluster of multimedia frames is identified by
comparing one or more visual samples, of the target character, with video data of each multimedia frame, and
comparing one or more voice samples, of the target character, with audio data of each multimedia frame; and
a program code for generating a target multimedia file, wherein the target multimedia file is generated by combining the one or more clusters of multimedia frames.
